(19) United States
(12) Patent Application Publication
(10) Pub. No.: US 2011/0067584 A1
(43) Pub. Date: Mar. 24, 2011

(54) MODULAR LINEAR PRINTING PRESS FOR PRINTING HOLLOW ARTICLES BY MEANS OF DIFFERENT PRINTING PROCESSES

(75) Inventors: Bruno Mueller, Tafers (CH); Philippe Cotting, Ependes (CH); Thomas Walther, Fribourg (CH); Iwan Kurt, Tafers (CH)

(73) Assignee: Polytype S.A., Fribourg (CH)

(21) Appl. No.: 12/921,960

(22) PCT Filed: Feb. 26, 2009
(86) PCT No.: PCT/EP09/01374

§ 371 Date: Nov. 5, 2010

(30) Foreign Application Priority Data
Mar. 11, 2008 (EP) 08152582.6-1251

(51) Int. Cl. B41F 17/00

(52) U.S. Cl. 101/35

(57) ABSTRACT

A linear printing machine with exchangeable printing modules for printing on hollow bodies. The machine includes a transport system including a drive, using which the hollow bodies to be printed on are transported through the linear printing machine and at least a first printing station and a second printing station which is arranged downstream of the first printing station in the conveying direction of the hollow bodies. At least one drying station dries the ink on the hollow bodies which have been printed on. A machine controller controls at least the transport of the hollow bodies through the linear printing machine, wherein each of the printing stations is prepared to accommodate a printing module comprising a drive of its own, and wherein the printing module can be connected to the machine controller via an interface, wherein the printing modules print on the hollow bodies using a printing method selected from screen printing and/or flexographic printing and/or offset printing and/or cold embossing and/or hot embossing and/or laser colour transfer and/or inkjet.

### CROSS REFERENCE TO RELATED APPLICATIONS

This application is the U.S. national phase application of PCT International Application No. PCT/EP2009/001374, filed Feb. 26, 2009, which claims priority to European Patent Application No. EP 08152582.6-1251, filed Mar. 11, 2008.

### FIELD OF THE INVENTION

The invention relates to a linear printing machine, preferably a rotary printing machine, for printing on hollow bodies which are held by spindles, wherein the hollow bodies are sequentially fed to a first and a second printing station, and a first printed image is printed on the hollow bodies using a first printing method in the first printing station and a second printed image is printed on the hollow bodies using a second printing method in the second printing station, wherein the first printing method and the second printing method can be the same printing method, for example screen printing, or can be different printing methods, for example screen printing and offset printing.

### BACKGROUND OF THE INVENTION

When printing on hollow bodies, offset printing is in many cases the preferred method because it is the most rational. This applies in particular when printing onto a white background. Since only relatively low ink layer thicknesses can be applied to the hollow body by means of offset printing, it is by contrast less suitable for printing on hollow bodies consisting of transparent material, since the thin ink layers thus produced appear pale and translucent. For these cases, there are therefore solutions in which the flat printing screen method is used for printing on transparent hollow bodies. In particular when printing on hollow bodies which exhibit large diameters, however, flat screens exhibiting large dimensions are required, which results in a very voluminous machine design and can lead to relatively large cycle times and a correspondingly low printing speed.

Printing machines in which hollow bodies are sequentially provided with printed images are known in the prior art. In most cases, these hollow bodies are arranged on a rotary disc around which the printing units are positioned in the form of satellites. As the rotary disc rotates, it guides the hollow bodies, which in most cases are held on one spindle, from one printing unit to the next, such that the hollow bodies can be printed on sequentially in the various printing units.

A printing machine in which cylindrical objects are printed on directly by rotary screens is for example known from U.S. Pat. No. 6,283,022. The rotary screen printing units are situated in a plurality of printing stations which are arranged along the circumference of a rotary disc which can be rotated about a vertical rotational axis, wherein the objects to be printed on are fixed to the rotary disc. Drying stations for drying the inks which are printed onto the objects are situated between the printing stations, radially outside the trajectory which the objects pass through.

A machine for printing on hollow bodies is known EP 1 468 827 B1, comprising a spindle disc which can be set in rotation in a timed manner and comprises a plurality of sequentially arranged spindle units comprising spindles onto which hollow bodies which are to be printed on can be fitted. While the printing stations comprising the rotary screen printing units lie radially outside the spindle trajectory which the hollow bodies to be printed on pass through, the drying stations are respectively arranged between two printing stations, radially within the spindle trajectory. This results in a relatively compact design for the printing machine, a relatively high printing speed and a high ink layer thickness on the hollow body.

DE 101 00 211 A1 discloses a printing machine for printing on round hollow bodies using consecutively arranged printing units which are designed in a row, wherein the printing mandrels onto which the hollow bodies to be printed on are placed are driven in synchrony with the printing units by toothed wheels.

WO 98/01302 discloses a rotary screen printing machine in which individual printing units are configured modularly and control modules are fully integrated within a digital composite network of the printing machine, wherein the individual printing units can be individually inserted into the rotary printing machine and exchanged and also individually programmed as autonomous modules.

### SUMMARY OF THE INVENTION

It is an object of the present invention to provide a printing machine for printing on hollow bodies in a plurality of sequentially arranged printing units for the same or different printing methods, wherein said printing machine allows a quick response to malfunctions at individual printing units and can be quickly adapted to altered production requirements.

Said linear printing machine comprises exchangeable printing modules for printing on hollow bodies and comprises a transport means including a drive, using which the hollow bodies to be printed on are transported through the linear printing machine, and also comprises at least a first printing station and a second printing station which is arranged downstream of the first printing station in the conveying direction of the hollow bodies, at least one drying station for drying the ink on the hollow bodies which have been printed on, and a machine controller which, for example as a central controller, controls the transport of the hollow bodies through the linear printing machine and the activities of the printing stations, wherein each of the printing stations is prepared to accommodate a printing module comprising a drive of its own, wherein the printing modules print on the hollow bodies using a printing method selected from screen printing and/or flexographic printing and/or offset printing and/or cold embossing and/or hot embossing and/or laser colour transfer and/or inkjet, wherein the first printing module can print on the hollow body using the same printing method, for example screen printing, in the first and second printing station, or the first printing module can print on the hollow body using a first printing method, for example screen printing, and the second printing module can print on the hollow body using a second printing method which is different to the first printing method, for example offset printing.

Each printing module can comprise a controller or module controller of its own. Said module controllers can be purely local controllers, i.e. the module controller only controls the activities of the respective module, while the machine controller controls co-ordinating the individual printing stations, inserting the hollow bodies into the linear printing machine and removing the hollow bodies from the linear printing machine.

The module controllers can however also be able to be connected to the machine controller and/or each other via an interface which is provided in each of the printing stations. In this case, they can be incorporated into the machine controller as sub-controllers and can receive signals from the machine controller and/or transmit signals to the machine controller. Less preferably, the module controller and/or each of the module controllers can however also be embodied such that it forms the central controller when it is docked and incorporates the machine controller as a subordinate controller or completely replaces it. If, in this case, a plurality of printing modules are docked in the printing stations, one of the module controllers can for example function as the central controller, while the controllers of the other printing modules are not used as central controllers; in the event of a defect in the module controller currently being used as the central controller, however, one of the other printing stations and/or module controllers can automatically assume the role of the central controller. Lastly, any of the module controllers of the docked printing modules can also form the central controller, together with the machine controller or without the machine controller.

In other words, the linear printing machine comprises a central part—referred to in the following as the machine base part—which comprises a driven transport means for transporting hollow bodies to be printed on through the linear printing machine. The central part of the linear printing machine can additionally comprise other devices, for example a device for loading the transport means with the hollow bodies to be printed on and/or a device for removing the hollow bodies which have been completely printed on, or a varnishing station for varnishing the hollow bodies which have been printed on. In keeping with the modular design of the linear printing machine, these parts can likewise be embodied as modules which can be docked and removed.

The linear printing machine also comprises at least two printing stations which are arranged sequentially in the conveying direction of the hollow bodies, such that when the hollow bodies are transported through the linear printing machine, they are transported through the first printing station and then through the second printing station. Other printing stations can be arranged downstream of the second printing station, wherein the number of printing stations can be predetermined by the manner in which the hollow bodies to be printed on are to be printed on.

The linear printing machine also comprises at least one drying station which is preferably provided downstream of the last of the printing stations. One drying station can also preferably be arranged after each of the printing stations. At least one of the printing modules can be a varnishing module which, like all the other printing modules on each of the printing stations, can be docked to the linear printing machine. The varnishing module can thus be docked in the first of the printing stations, in order for example to prime the hollow body, or downstream of the last of the printing modules, in order to fix the inks which have been applied to the hollow body.

The machine base part of the linear printing machine comprises a machine controller which controls at least the transport of the hollow bodies through the linear printing machine. In addition, the machine controller can also control loading the linear printing machine, the drying process or processes and/or the varnishing process and/or removing the hollow bodies which have been printed on from the linear printing machine and can at least help to control the printing process as a whole.

The printing stations of the linear printing machine are prepared docking stations. An autonomous printing module can be connected to the machine base part via the docking station of a printing station. “Autonomous printing module” means that the printing module is independent of the machine base part in drive terms and preferably also in control terms, i.e. the printing module has a printing module drive of its own and preferably a printing module controller of its own. The printing module can therefore be operated independently of the machine base part. The printing stations of a linear printing machine, or of a plurality of linear printing machines of the same type, which are embodied as docking stations are identical, i.e. they each comprise the same prepared connecting points and/or interfaces. All the printing modules have complementary connecting points or complementary interfaces which match the connecting points and interfaces, such that each of the printing modules in each of the printing stations can be connected to the machine base part. Consequently, any printing module can be connected to the printing machine base part in either the first printing station, the second printing station or any other printing station, to form a linear printing machine.

In order to be docked positionally securely to the printing stations, the printing modules can for example be deposited onto rails by means of a fork lift truck or ceiling crane, on which they can then be moved to the machine base part and securely locked in place in the production position. Alternatively, docking can establish a secure production connection directly between the machine base part and the printing module, for example via latching elements or screw connections which can be established after docking. In this case, the printing module can for example be mounted on a carriage and docked, together with said carriage, to the machine base part. In order to ensure that the printing modules are quickly exchanged or swapped, other quick-release connection systems which are known in the prior art can also be used.

Each of the printing modules preferably comprises a module controller of its own which can be used once it has been docked to the linear printing machine as described above. Even when printing modules are undocked from the linear printing machine, however, the module controller can control the co-operation between the printing module and devices which lie outside the linear printing machine. A service module can for example be situated alongside or apart from the linear printing machine, wherein the free printing module can be docked to said service module. The service module can for example be a module for washing the printing module, performing maintenance on the printing module or repairing the printing module. The service module preferably comprises the same interfaces and connecting points to the printing module as each of the printing stations.

The individual controllers of the printing modules, which once docked in the printing station can for example be connected to each other via interfaces using a data bus, can together form a decentralised controller for the printing process which alone controls the printing process.

The printing modules are different printing units using which the hollow bodies can be printed on using either screen printing, flexographic printing, offset printing, cold embossing, hot embossing, laser colour transfer or inkjet. Each of these different printing modules can be used in each of the printing stations, i.e. if there are n printing stations, images can be printed onto the hollow body using a maximum of n different printing methods, wherein the production run alone decides which printing module is used at which printing station of the linear printing machine. Thus, a printing module which is embodied as a flexographic printing unit can for example be used at the first printing station in one production process, while a printing module which is formed by an offset printing unit can be used at the same point in another production process. Each printing station can in principle accommodate each printing module, irrespective of the method according to which it prints.

In order to ensure that the hollow bodies are printed on true to register, it is preferable for the linear printing machine to comprise a positioning system which ensures that the hollow bodies are transported to the printing stations and from printing station to printing station as true to register as possible. To this end, a mandrel which bears the hollow body to be printed on can for example comprise a position marker which has to have a particular placement when the hollow body enters the first printing station. Whether this position is maintained can for example be detected by suitable sensors and monitored by the machine controller. The mandrels are preferably rotary-driven, hence if the machine controller determines a deviation between the actual position and the target position of the mandrel, it can correct the deviation before the beginning of printing by actuating the mandrel drive. To this end, however, each mandrel has to have an individual drive and be able to be individually accelerated or decelerated by the machine controller. The comparison between the target position and the actual position can be repeated whenever a printing station is entered.

Alternatively, the deviation discovered by the machine controller can be transmitted to the module controller of the printing module in question by the machine controller, such that the module controller can for example delay advancing the printing unit of the printing module. Instead of checking the position of the mandrel, it is alternatively also possible to monitor the position of the hollow body itself, which is advantageous since spoilage due to a hollow body on the mandrel slipping in the circulating direction during the printing process can be avoided. The register position can be monitored in this way using a marking on the hollow body which is detected by means of a sensor which forms part of the machine base and is connected via a signal connection to the machine controller. The sensor transmits a signal to the machine controller which calculates actual position data for the hollow body from the signal by means of an algorithm and compares the actual position data with target position data stored in the machine controller, for example in a memory. If the machine controller determines a deviation between the target position and the actual position, a corresponding correction signal can be transmitted to the module controller.

In order to check the position of the hollow body as it enters the printing station, each printing module can comprise a sensor using which the true-to-register position of the hollow body to be printed on can be checked, preferably before the beginning of printing. If this sensor determines a deviation, it for example sends a signal to the module controller. The signal received is processed in the module controller, and the module controller then triggers the correction, directly or via the machine controller.

The mandrels which are driven or freely rotated about their rotational axis are preferably mounted in a mandrel bearing which is connected to the transport unit or formed by the transport unit. If the mandrels are driven, they can be connected via a gear system to a drive via a mandrel pedestal which for example comprises an outer toothing, wherein each mandrel can be individually driven, or the mandrels are combined into groups comprising a common drive, or all the mandrels are jointly driven by a single drive. In this case, the drive can be transferred from the drive motor onto the individual mandrel by means of toothed belts or chains.

Two, three or more printing mandrel bearings can preferably be combined to form a unit, in order to be able to accommodate a corresponding number of printing mandrels. Such a composite of printing mandrel bearings can be driven as a carriage, for example by a linear motor or by means of a worm gear, as described for example in EP 0 909 728 A1, the teaching of which with respect to driving an object support—in the present invention, a carriage—using two, three or more printing mandrel bearings is incorporated into this application. The teaching of DE 198 03 617 C1 with respect to driving an object support and/or printing mandrel bearing using a transport wheel is likewise incorporated into this application. The drive mechanisms of the two documents mentioned can also be used in combination with the present invention. In addition, it is also possible for a plurality of printing mandrel bearings to be realised in chain members of a circulating chain, such that it is for example possible to realise a timed or continuous transport movement of the individual printing mandrel bearings and therefore of the printing mandrels.

In order to describe the preferred embodiment of the mandrel bearing, the teaching of the patent application “Centring a Mandrel Bearing”, filed with the Office by the Applicant on the same date, is incorporated into this application.

The transport unit is preferably formed as a continuous belt or continuous chain comprising a linear transport path section in the region of the printing stations, wherein the continuous belt or continuous chain can be tensed between two rollers which are mounted at a distance, wherein at least one of the two rollers is driven by a motor and the two rollers preferably exhibit the same diameter, such that the transport path as a whole can be described thus: two straight lines which run in parallel and are connected at each of their two ends to a semi-circular curve which exhibits an identical diameter. Alternatively, the rollers can also exhibit different diameters and/or at least the linear transport path section which comprises the printing stations can be sub-divided into two limbs of what is then a triangular transport path by a third roller, for example a deflecting roller which is not driven. The hollow bodies are preferably guided on the transport unit in a timed manner by the linear printing machine, wherein the cycle time corresponds to the longest printing time of a hollow body by a printing module plus the travelling time from one printing station to the next, i.e. the feed movement. Since different printing methods can necessitate different printing times, and not all the printing methods are used in each production, the cycle time can be adapted to the respective production and is in this respect adjustable.

As already stated, the linear printing machine comprises at least one drying station which preferably lies downstream of the last printing station in the transport direction of the hollow bodies. Alternatively, one drying station can also be arranged between each two printing stations, such that drying is performed immediately after each printing process by a printing module. It is likewise conceivable for each mandrel to be assigned a drying station which can for example form a design unit with the mandrel and be fastened on the transport means together with the mandrel. Such a drying means is preferably attached on the side of the mandrel which lies opposite the printing gap formed between a hollow body and a printing unit. This arrangement has the advantage that printing on the hollow body and drying are performed partially simultaneously, which can result in an increase in production per unit of time. Alternatively, the drying station can also be an integrated part of the printing module and, together with the printing module, can be attached to and/or detached from the machine base part. The drying stations comprise radiation sources for drying the ink on the hollow bodies, for example UV radiation sources, LEDs or e-beamers for emitting electron beams, wherein if two or more drying stations are used, all the drying stations can comprise the same radiation sources, or each of the drying stations can comprise a different radiation source. If different radiation sources are advantageous for effectively drying different printing methods, the/each drying station can comprise a plurality of different radiation sources which can be activated as required.

### BRIEF DESCRIPTION OF THE DRAWINGS

The invention is described below on the basis of a preferred example embodiment. There is shown:

FIG. 1 is a top view onto a linear printing machine in accordance with an exemplary embodiment of the invention.

### DETAILED DESCRIPTION OF THE PREFERRED EMBODIMENT

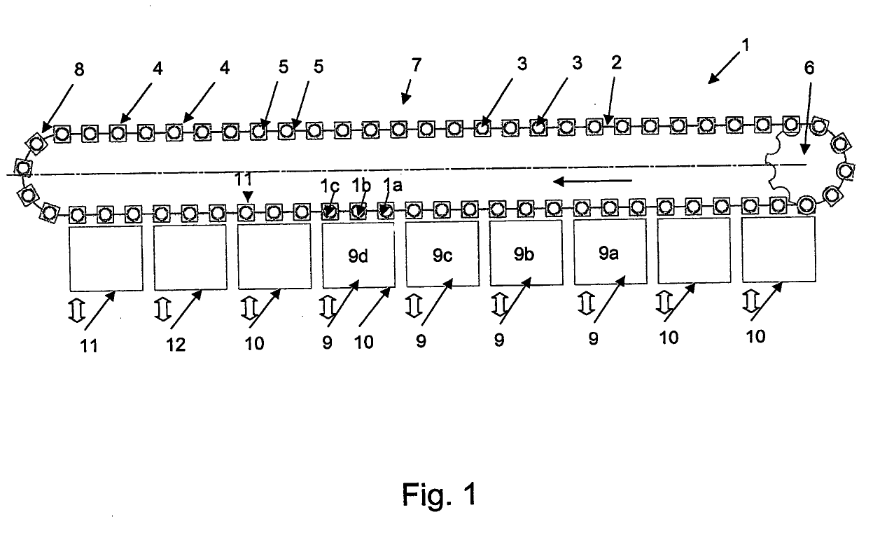

FIG. 1 is a schematic top view onto a linear printing machine 1 in accordance with the invention which shows the essential elements of the linear printing machine 1. The linear printing machine 1 comprises a transport means 2 in the form of a linear motor, a belt or a chain. Mandrels 3 which each comprise a mandrel bearing 4 are fastened on the transport means 2. Each of the mandrels 3 bears one hollow body 5. The transport means 2 is tensed between two rollers 6, wherein at least one of the rollers 6 is rotary-driven. The input means for inputting the hollow bodies 5 into the linear printing machine 1 and the removing means for removing the hollow bodies 5 are not shown in FIG. 1.

The transport means 2 is embodied in the shape of an oval comprising two linear and straight transport paths 7 which run parallel to each other and two semi-circles 8 which connect the straight transport paths 7. The diameter of the semi-circles is determined by the diameter of the rollers 6 and is equal to the distance between the two straight transport paths 7. A plurality of printing stations 10 are formed along one of the straight transport paths 7.

A printing module 9 is docked in each of four printing stations 10, wherein these can be four different printing modules 9: thus, 9a can for example represent offset printing; 9b can for example represent flexographic printing; 9c can for example represent screen printing; and 9d can for example represent inkjet printing. If the hollow bodies 5 are then guided past the printing stations 10 in the direction indicated by the arrow, the hollow body 5 can be sequentially printed on by the offset printing module 9a, the flexographic printing module 9b, the screen printing module 9c and the inkjet printing module 9d. Once printed on, the hollow body can additionally also be coated with varnish in a varnishing station 12, before it is dried in a preferably stationary drying station 11. Alternatively, identical printing modules 9 can also be formed in the printing stations 10, and the hollow body 5 can be printed on in the sequentially arranged printing stations 10 using identical printing methods but different inks.

The arrows illustrated beneath the printing stations 10 which each comprise a tip pointing into the printing station 10 and a tip pointing in the opposite direction are intended to indicate that printing modules 9 can be docked to or removed from said printing station 10 as desired, wherein any printing module 9a to 9d can be used in each of the printing stations 10, including if required other modules 9 which are not shown here, such as for example laser modules for burning in symbols or figures, perforation modules for creating perforation lines, etc.

The last printing module 9 of the linear printing machine 1 can optionally be followed by a varnishing station 12 which can likewise be embodied as a module 9, i.e. it is only docked to the linear printing machine 1 if required and can also be docked at any other printing station 10 of the linear printing machine 1, including for example at the first of the printing stations 10. One drying station 11 can be arranged downstream of the last printing station 10 or after each printing station 10, wherein one or all of the drying stations 11 can be fixedly connected to the linear printing machine; alternatively, they can be fixedly connected to the printing modules 9 or, less preferably, can themselves form modules 9 which can be docked to the linear printing machine.

1-19. (canceled)

20. A linear printing machine with exchangeable printing modules for printing on hollow bodies, comprising:
a transport means including a drive, configured to transport the hollow bodies to be printed on through the linear printing machine;
at least a first printing station and a second printing station which is arranged downstream of the first printing station in the conveying direction of the hollow bodies;
at least one drying station for drying the ink on the hollow bodies which have been printed on; and
a machine controller which controls at least the transport of the hollow bodies through the linear printing machine,
wherein each of the printing stations is prepared to accommodate a printing module comprising a drive of its own, and wherein the printing module is configured for connection to the machine controller via an interface,
wherein the printing modules print on the hollow bodies using a printing method selected from screen printing and/or flexographic printing and/or offset printing and/or cold embossing and/or hot embossing and/or laser colour transfer and/or inkjet.

21. The linear printing machine with exchangeable printing modules for printing on hollow bodies according to claim 20, wherein the linear printing machine also comprises a positioning system for feeding the hollow bodies to the printing stations true to register.

22. The linear printing machine with exchangeable printing modules for printing on hollow bodies according to claim 20, wherein each of the printing modules has a sensor for monitoring the true-to-register position of the hollow body before the beginning of printing by the printing module.

23. The linear printing machine with exchangeable printing modules for printing on hollow bodies according to claim 22, wherein if a deviation in the target register position is discovered at the beginning of printing by a printing module, the machine controller or the controller of the printing module delays advancing a printing unit of the printing module onto the hollow body to be printed on, in accordance with printer's imprints or independently of printer's imprints.

24. The linear printing machine with exchangeable printing modules for printing on hollow bodies according to claim 23, wherein if a deviation in the target register position is discovered at the beginning of printing, the machine controller or the controller of a printing module accelerates or delays actuating a mandrel drive, in accordance with printer's imprints.

25. The linear printing machine with exchangeable printing modules for printing on hollow bodies according to claim 20, wherein the hollow bodies are held on mandrels which are mounted in a bearing in the transport means such that they can be rotated about their rotational axis.

26. The linear printing machine with exchangeable printing modules for printing on hollow bodies according to claim 20, wherein the transport means is a linear motor comprising a linear transport path section in the region of the printing stations.

27. The linear printing machine with exchangeable printing modules for printing on hollow bodies according to claim 20, wherein the drying station is arranged downstream of the last printing station in the transport direction of the hollow bodies.

28. The linear printing machine with exchangeable printing modules for printing on hollow bodies according to claim 20, wherein one drying device is arranged between each two adjacent printing stations.

29. The linear printing machine with exchangeable printing modules for printing on hollow bodies according to claim 20, wherein one drying device is arranged between the or downstream of each printing station and downstream of each varnishing station.

30. The linear printing machine with exchangeable printing modules for printing on hollow bodies according to claim 20, wherein the drying station is an integrated part of the printing module and, together with the printing module, is configured to be attached to and/or detached from the linear printing machine.

31. The linear printing machine with exchangeable printing modules for printing on hollow bodies according to claim 20, wherein the drying stations for drying the ink on the hollow bodies comprise radiation sources which act on the hollow body using one of UV and/or an LED and/or an electron beam.

32. The linear printing machine with exchangeable printing modules for printing on hollow bodies according to claim 31, wherein if there are a plurality of drying stations, all the drying stations comprise a uniform radiation source.

33. The linear printing machine with exchangeable printing modules for printing on hollow bodies according to claim 31, wherein at least one or more or all of the drying stations comprise combined radiation sources using UV and/or LEDs and/or electron beams.

34. The linear printing machine with exchangeable printing modules for printing on hollow bodies according to claim 20, wherein the transport means is formed using a transport chain.

35. The linear printing machine with exchangeable printing modules for printing on hollow bodies according to claim 20, wherein the hollow body can be printed on using a first printing method in the first printing station and can be printed on using another printing method which is different from the first printing method in at least the second printing station.

36. The linear printing machine with exchangeable printing modules for printing on hollow bodies according to claim 20, wherein the hollow body can be printed on using a first printing method in the first printing station and can be printed on using the same printing method as the first printing method or a different printing method to the first printing method in at least the second printing station.

37. The linear printing machine with exchangeable printing modules for printing on hollow bodies according to claim 20, wherein the controllers of the printing modules form a decentralised controller for the printing process which alone controls the printing process.

38. The linear printing machine with exchangeable printing modules for printing on hollow bodies according to claim 20, wherein each printing module comprises a controller or module controller of its own which controls the printing process in conjunction with the decentralised controller for the printing process.
